(19) United States
(12) Patent Application Publication
(10) Pub. No.: US 2025/0385594 A1
(43) Pub. Date: Dec. 18, 2025

(54) REGULATOR AND INTEGRATED CIRCUIT INCLUDING THE SAME

(71) Applicant: SAMSUNG ELECTRONICS CO., LTD., Suwon-si (KR)

(72) Inventors: Eunsang JANG, Suwon-si (KR); Sanghyung KIM, Suwon-si (KR); Hanbyul KIM, Suwon-si (KR); YONG-SEONG ROH, Suwon-si (KR); Youngjin MOON, Suwon-si (KR); Seongmun PARK, Suwon-si (KR); SEUNGGYU LEE, Suwon-si (KR)

(73) Assignee: SAMSUNG ELECTRONICS CO., LTD., Suwon-si (KR)

(21) Appl. No.: 19/227,832

(22) Filed: Jun. 4, 2025

(30) Foreign Application Priority Data
Jun. 18, 2024 (KR) 10-2024-0079202
Oct. 31, 2024 (KR) 10-2024-0152692

(51) Int. Cl. H02M 1/00; H02M 1/44; H02M 3/158

(52) U.S. Cl. CPC H02M 1/0048; H02M 1/44; H02M 3/158

(57) ABSTRACT

A regulator may amplify a difference between an input voltage and a feedback voltage to obtain and apply an amplified voltage to a first node, and buffer the amplified voltage to obtain and apply a power gate voltage to a second node. The regulator may include a first power transistor connected to the second node, a first electrode connected to a power supply voltage, and a second electrode connected to an output node, a voltage dividing circuit configured to generate the feedback voltage based on an output voltage of the output node, a current sensor configured to generate an sensing current based on a current of the first power transistor, a loop circuit configured to generate a loop current based on the power gate voltage and the output voltage, and a stabilizing circuit configured to suppress oscillation of the output voltage.

### CROSS-REFERENCE TO RELATED APPLICATION

This application claims priority to and the benefits of Korean Patent Application No. 10-2024-0079202 filed with the Korean Intellectual Property Office on Jun. 18, 2024 and Korean Patent Application No. 10-2024-0152692 filed with the Korean Intellectual Property Office on Oct. 31, 2024, the entire contents of which are incorporated herein by reference.

### BACKGROUND

The present disclosure relates to a regulator, and a power management integrated circuit including the regulator.

Power management integrated circuits (ICs) may generate supply voltages to provide power to electronic components. Levels of the supply voltages may be determined based on required performance of each electronic component. Such a power management IC may include a regulator that generates supply voltages of various levels. As power consumption of electronic components increases, oscillation may occur in an output voltage output by the regulator. The regulator may require circuitry to suppress variations in the output voltage in order to provide a stable output voltage to electronic components.

### SUMMARY

One or more embodiments of the present disclosure provide a regulator for controlling overshoot or undershoot of an output voltage and an integrated circuit including the same.

According to an aspect of the present disclosure, a regulator may include: an amplifier configured to amplify a difference between an input voltage and a feedback voltage to obtain an amplified voltage, and apply the amplified voltage to a first node; a buffer connected to the first node and configured to buffer the amplified voltage to obtain a power gate voltage and apply the power gate voltage to a second node; a first power transistor including a gate electrode connected to the second node, a first electrode connected to a power supply voltage, and a second electrode connected to an output node; a voltage dividing circuit configured to generate the feedback voltage based on an output voltage of the output node; a current sensor configured to generate an sensing current based on a current of the first power transistor; a loop circuit configured to generate a loop current based on the power gate voltage and the output voltage; and a stabilizing circuit configured to suppress oscillation of the output voltage based on a sum current of the sensing current and the loop current.

According to another aspect of the present disclosure, a regulator may include: a calculation amplifier configured to amplify a difference between an input voltage and a feedback voltage to obtain an amplified voltage, and output the amplified voltage to a first node; a buffer connected to the first node and configured to buffer the amplified voltage to obtain a power gate voltage and apply the amplified voltage to a second node; a power transistor connected to the second node and the output node; a current sensor configured to generate an sensing current based on a current of the power transistor and provide the sensing current to a zero control node; a first transistor including a gate electrode connected to the zero point control node, a first electrode connected to the first node, and a second electrode connected to ground; and a loop circuit connected to the second node, the output node, and the zero control node, and configured to increase or decrease a zero gate voltage of the zero control node based on a change in a load current flowing in a load connected to the output node.

According to another aspect of the present disclosure, an operating method of a regulator may include: amplifying a difference between an input voltage and a feedback voltage to obtain an amplified voltage; applying the amplified voltage to a first node connected to a buffer; buffering the amplified voltage to obtain a power gate voltage; applying the power gate voltage to a second node connected to a power transistor and a loop circuit; applying an output voltage generated based on the power gate voltage to an output node connected to a current sensor and the loop circuit; generating a sensing current based on the output voltage and providing the sensing current to a zero control node connected to a gate electrode of the first transistor and the loop circuit; and providing a loop current from the loop circuit to the zero control node or from the zero control node to the loop circuit based on a change in the output voltage.

### BRIEF DESCRIPTION OF THE DRAWINGS

FIG. 1 illustrates a view for describing an integrated circuit including a regulator according to an embodiment.

FIG. 2 illustrates a view for describing a regulator that controls an output voltage of undershoot according to an embodiment.

FIG. 3 illustrates a view for describing a regulator that reduces an output voltage of overshoot according to an embodiment.

FIG. 4 illustrates a view for describing a fast loop circuit for generating a loop current according to an embodiment.

FIG. 5 illustrates a view for describing a fast loop circuit for pooling a loop current according to an embodiment.

FIG. 6 illustrates a view for describing a slow change of a zero point according to an embodiment.

FIG. 7 illustrates a view for describing a rapid change of a zero point according to an embodiment.

FIG. 8 illustrates a view for describing an oscillation of an output voltage according to an embodiment.

FIG. 9 illustrates a view for describing a regulator that regulates an output voltage based on a loop current according to an embodiment.

FIG. 10 illustrates a flowchart showing an operating method of a regulator according to an embodiment.

FIG. 11 illustrates a view for describing a system according to an embodiment.

FIG. 12 illustrates a view for describing a mobile device according to an embodiment.

FIG. 13 illustrates a view for describing a storage system according to an embodiment.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

To clearly describe the present disclosure, parts that are irrelevant to the description are omitted, and like numerals refer to like or similar components throughout the specification.

In addition, unless explicitly described to the contrary, the word “comprise” and variations such as “comprises” or “comprising” will be understood to imply the inclusion of stated elements but not the exclusion of any other elements.

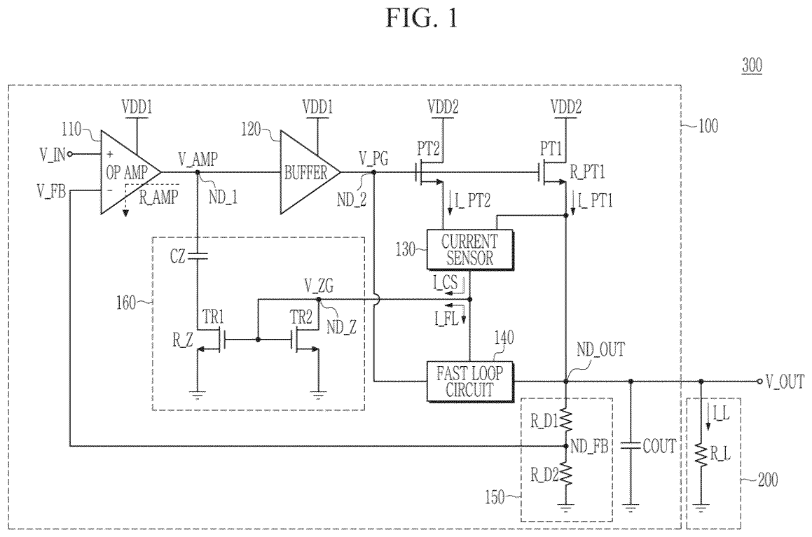

FIG. 1 illustrates a view for describing an integrated circuit including a regulator according to an embodiment.

Referring to FIG. 1, an integrated circuit 300 may include a regulator 100 and a load device 200. The integrated circuit 300 may regulate the power supply to the load device 200 using the regulator 100.

In an embodiment, the regulator 100 may regulate an input voltage V_IN, and may provide an output voltage V_OUT to the load device 200. In an embodiment, the regulator 100 may include a calculation amplifier 110, a buffer 120, a current sensor 130, a fast loop circuit 140, a voltage dividing circuit 150, a stabilizing circuit 160, a first power transistor PT1, a second power transistor PT2, and an output capacitor COUT.

In an embodiment, the calculation amplifier 110 may receive the input voltage V_IN and a feedback voltage V_FB, and may output an amplified voltage V_AMP. The calculation amplifier 110 may be driven based on a first power supply voltage VDD1. An output terminal of the calculation amplifier 110 may be connected to a first node ND_1. In an embodiment, the calculation amplifier 110 may apply the amplified voltage V_AMP that amplifies a difference between the input voltage V_IN and the feedback voltage V_FB to the first node ND_1.

In an embodiment, the buffer 120 may buffer the amplified voltage V_AMP, and may output a power gate voltage V_PG. The buffer 120 may be driven based on the first power supply voltage VDD1. In an embodiment, an input terminal of the buffer 120 may be connected to the first node ND_1, and an output terminal thereof may be connected to a second node ND_2. In an embodiment, the buffer 120 may apply the power gate voltage V_PG that buffers the amplified voltage V_AMP applied to the first node ND_1 to the second node ND_2.

In an embodiment, the second power transistor PT2 may provide a second power transistor current I_PT2 based on the power gate voltage V_PG to the current sensor 130. The second power transistor PT2 may be connected to the second node ND_2, a second power voltage VDD2, and the current sensor 130. In an embodiment, the second power supply voltage VDD2 may be less than the first power supply voltage VDD1. In an embodiment, a gate electrode of the second power transistor PT2 may be connected to the second node ND_2, a first electrode of the second power transistor PT2 may be connected to the second power voltage VDD2, and a second electrode of the second power transistor PT2 may be connected to the current sensor 130. In an embodiment, the first electrode may be a drain electrode. In an embodiment, the second electrode may be a source electrode. In an embodiment, when the power gate voltage V_PG is applied to the gate electrode of the second power transistor PT2, a second power transistor current I_PT2 may flow from the second electrode of the second power transistor PT2 to the current sensor 130.

In an embodiment, the first power transistor PT1 may provide a first power transistor current I_PT1 based on the power gate voltage V_PG to the current sensor 130. The first power transistor PT1 may be connected to the second node ND_2, the second power voltage VDD2, and an output node ND_OUT. In an embodiment, a gate electrode of the first power transistor PT1 may be connected to the second node ND_2, a first electrode of the fist power transistor PT1 may be connected to the second power voltage VDD2, and a second electrode of the first power transistor PT1 may be connected to the output node ND_OUT. In an embodiment, when the power gate voltage V_PG is applied to the gate electrode of the first power transistor PT1, a first power transistor current I_PT1 may flow from the second electrode of the first power transistor PT1 to the output node ND_OUT.

In the embodiment, the first power transistor PT1 may apply the output voltage V_OUT to the output node ND_OUT based on the power gate voltage V_PG applied from the second node ND_2.

In the embodiment, the current sensor 130 may output a sensing current I_CS based on the first power transistor current I_PT1 and the second power transistor current I_PT2. The current sensor 130 may be connected to the first power transistor PT1, the second power transistor PT2, and a zero control node ND_Z.

In an embodiment, sizes of the first power transistor PT1 and the second power transistor PT2 may be N:1 (where N is a positive number greater than 1). In an embodiment, a magnitude of the first power transistor current I_PT1 and the second power transistor current I_PT2 may be N:1. In an embodiment, when the first power transistor current I_PT1 increases, the second power transistor current I_PT2 may increase. In an embodiment, as the second power transistor current I_PT2 increases, the sensing current I_CS may increase. In the embodiment, the current sensor 130 may output the increased sensing current I_CS when the first power transistor current I_PT1 increases.

In an embodiment, the fast loop circuit 140 may generate a loop current I_FL based on changes in the power gate voltage V_PG and the output voltage V_OUT, and may provide the loop current I_FL to the stabilizing circuit 160. The fast loop circuit 140 may be connected to the second node ND_2, the output node ND_OUT, and the zero control node ND_Z. In an embodiment, the fast loop circuit 140 may generate the loop current I_FL based on a change in the power gate voltage V_PG of the second node ND_2 and the output voltage V_OUT of the output node ND_OUT, and may push the loop current I_FL to the zero control node ND_Z. In an embodiment, the fast loop circuit 140 may pull the loop current _FL from the zero control node ND_Z based on the change in the power gate voltage V_PG of the second node ND_2 and the output voltage V_OUT of the output node ND_OUT.

In an embodiment, the voltage dividing circuit 150 may generate the feedback voltage V_FB based on the output voltage V_OUT of the output node ND_OUT. In an embodiment, the feedback voltage V_FB may be applied to the calculation amplifier 110. In an embodiment, the voltage dividing circuit 150 may include a first dividing resistor R_D1 and a second dividing resistor R_D2. In an embodiment, the first dividing resistor R_D1 may be connected between the output node ND_OUT and the feedback node ND_FB. In an embodiment, the second dividing resistor R_D2 may be connected between the feedback node ND_FB and ground. In an embodiment, the voltage dividing circuit 150 may generate the feedback voltage V_FB based on a resistance ratio of the first dividing resistor R_D1 and the second dividing resistor R_D2.

In an embodiment, the stabilizing circuit 160 may be connected to the first node ND_1, the current sensor 130, and the fast loop circuit 140. In an embodiment, the stabilizing circuit 160 may suppress oscillation of the output voltage V_OUT based on a sum of the sensing current I_CS and the loop current I_FL flowing in the zero control node ND_Z.

In an embodiment, the stable circuit 160 may include a first transistor TR1, a second transistor TR2, and a zero capacitor CZ. In the stable circuit 160, the gates of the first transistor TR1 and the second transistor TR2 are connected to each other, establishing a stable biasing point. The zero capacitor CZ may be used to manage a pole-zero relationship of a transfer function of the stable circuit 160, in which poles correspond to frequencies where the system gain becomes infinite, while zeros are frequencies where the gain becomes zero.

In an embodiment, the zero capacitor CZ may be connected between the first node ND_1 and the first transistor TR1.

In an embodiment, the first transistor TR1 may be connected to the zero capacitor CZ, the zero control node ND_Z, and ground. In an embodiment, a gate electrode of the first transistor TR1 may be connected to the zero control node ND_Z, a first electrode of the first transistor TR1 may be connected to the zero capacitor CZ, and a second electrode of the first transistor TR1 may be connected to ground. In an embodiment, a zero gate voltage V_ZG of the zero control node ND_Z may be applied to the gate electrode of the first transistor TR1. In an embodiment, the second transistor TR2 may be connected to the zero control node ND_Z, and ground. In an embodiment, the gate electrode and the first electrode of the second transistor TR2 may be connected to the zero control node ND_Z, and the second electrode of the second transistor TR2 may be connected to ground. In an embodiment, the zero gate voltage V_ZG of the zero control node ND_Z may be applied to the gate electrode of the second transistor TR2.

In an embodiment, the first transistor TR1 and the second transistor TR2 may form a current mirror. In an embodiment, a sum of the sensing current I_CS and the loop current I_FL may flow through the second transistor TR2. In an embodiment, a current obtained by mirroring the sum of the sensing current I_CS and the loop current I_FL may flow through the first transistor TR1.

In an embodiment, the output capacitor COUT may be charged with a charge corresponding to the output voltage V_OUT. The output voltage V_OUT may be applied to a load circuit 200.

In the embodiment, the load circuit 200 may be connected to the output node ND_OUT. In an embodiment, the load circuit 200 may be a circuit that utilizes the output voltage V_OUT. In an embodiment, the load circuit 200 may be included in a system-on-chip processor, an application processor, a memory controller, or a display driver.

In an embodiment, the load circuit 200 may include a load resistor R_L and ground. The load resistor R_L may be connected between the output node ND_OUT and ground. In an embodiment, a load current I_L may flow in the load circuit 200 depending on the output voltage V_OUT.

In an embodiment, when the load current I_L flowing in the load circuit 200 increases, the output voltage V_OUT may decrease. In an embodiment, when the load current I_L flowing in the load circuit 200 decreases, the output voltage V_OUT may increase. In an embodiment, the regulator 100 may push a loop current I_FL to the first transistor TR1 to increase the output voltage V_OUT when the output voltage V_OUT decreases according to the load current I_L. In an embodiment, the regulator 100 may pull the loop current I_FL from the first transistor TR1 to reduce the output voltage V_OUT when the output voltage V_OUT increases according to the load current I_L.

In an embodiment, the regulator 100 may include a first dominant pole, a second dominant pole, and a zero point. In an embodiment, the first dominant pole may be expressed by Equation 1.

$${P}_{1} = \frac{1}{{R}_{AMP} {C}_{Z}} \qquad ( Equation 1 )$$

In Equation 1, P₁may be the first dominant pole P1. R_{AMP}may be a resistor R_AMP of the calculation amplifier 110. C_{Z}may be the zero capacitor CZ. In an embodiment, the first dominant pole P1 may be determined by the resistor R_AMP of the calculation amplifier 110 and the zero capacitor CZ.

In an embodiment, the second dominant pole may be expressed by Equation 2.

$${P}_{2} = \frac{1}{( {R}_{PT 1} \vert \vert {R}_{L} ) {C}_{OUT}} \qquad ( Equation 2 )$$

In Equation 2, P₂may be the second dominant pole P2. R_{PT1}may be a resistor R_PT1 of the first power transistor PT1. R_{L}may be a load resistor R_L. C_{OUT}may be the zero capacitor COUT. In an embodiment, the second dominant pole P2 may be determined by the resistor R_PT1 of the first power transistor PT1, the load resistor R_L, and the output capacitor COUT.

In an embodiment, a zero point may be expressed by Expression 3.

$$Z = \frac{1}{{R}_{Z} {C}_{Z}} \qquad ( Equation 3 )$$

In Equation 3, Z may be the zero point Z. R_{Z}may be a resistor R_Z of the first transistor TR1. C_{Z}may be the zero capacitor CZ. In an embodiment, the zero point Z may be determined by the resistor R_Z of the first transistor TR1 and the zero capacitor CZ.

In an embodiment, in order for the output voltage V_OUT of the regulator 100 to be constant, a position of the zero point Z that cancels the second dominant pole P2 in a frequency domain and a position of the second dominant pole P2 may need to be close.

In an embodiment, a position of the second dominant pole P2 in the frequency domain may vary depending on the load current I_L. In an embodiment, the load resistor R_L may vary depending on the load current I_L. As the load resistor R_L changes, the position of the second dominant pole P2 in the frequency domain may change. If the position of the second dominant pole P2 changes, the position of the zero point Z may also need to change to eliminate the second dominant pole P2.

In an embodiment, the regulator 100 may include a fast loop circuit 140 that changes the position of the zero point Z depending on the position of the second dominant pole P2 that varies in the frequency domain. In an embodiment, the fast loop circuit 140 may adjust the position of the zero point Z in the frequency domain and control the output voltage V_OUT to be constant by pushing the loop current I_FL to the first transistor TR1 or pulling the loop current I_FL from the first transistor TR1 based on a change in the power gate voltage V_PG and the output voltage V_OUT according to the load current I_L.

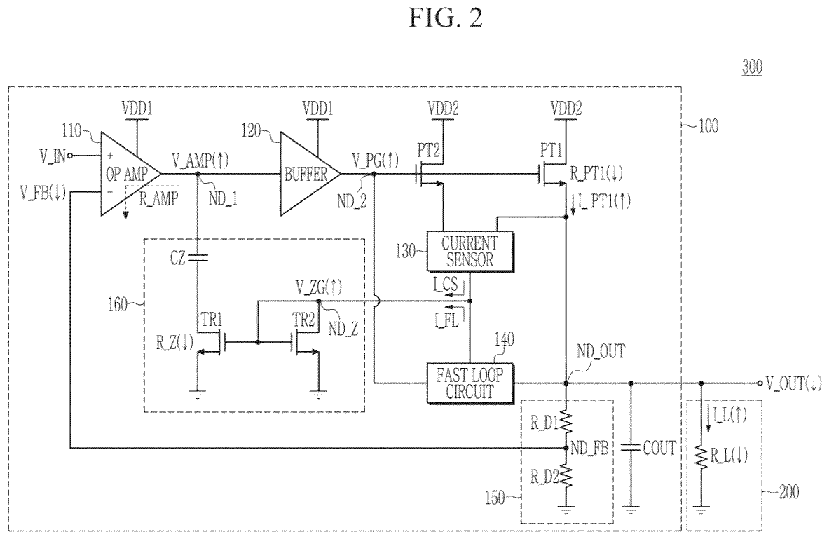

FIG. 2 illustrates a view for describing a regulator that controls an output voltage undershoot according to an embodiment.

In FIG. 2, an operation of the regulator 100 is explained in the case where a load of the load circuit 200 increases. Referring to FIG. 2, as the load of the load circuit 200 increases, the load current I_L may increase. In an embodiment, as the load current I_L increases, the load resistor I_R may decrease. As the load resistance I_R decreases, the position of the second dominant pole P2 in the frequency domain may change from a low frequency region to a high frequency region.

In an embodiment, if the load current I_L increases, the output voltage V_OUT may decrease. In an embodiment, a change in the output voltage V_OUT according to an increase in the load current I_L may correspond to an undershoot.

In an embodiment, if the output voltage V_OUT decreases, the feedback voltage V_FB may decrease. In an embodiment, the voltage dividing circuit 150 may generate a reduced feedback voltage V_FB based on the reduced output voltage V_OUT. In an embodiment, the voltage dividing circuit 150 may apply the reduced feedback voltage V_FB to the calculation amplifier 110.

In an embodiment, if the feedback voltage V_FB decreases, the amplified voltage V_AMP, which amplifies a difference between the input voltage V_IN and the feedback voltage V_FB, may increase. In an embodiment, the calculation amplifier 110 may apply the increased amplified voltage V_AMP to the first node ND_1 based on the input voltage V_IN and the reduced feedback voltage V_FB.

In an embodiment, as the amplified voltage V_AMP increases, the power gate voltage V_PG may increase. In an embodiment, the buffer 120 may apply an increased power gate voltage V_PG to the second node ND_2 based on the increased amplified voltage V_AMP.

In an embodiment, as the power gate voltage V_PG increases, the resistor R_PT1 of the first power transistor PT1 may decrease. In an embodiment, as the power gate voltage V_PG increases, the first power transistor current I_PT1 may increase.

In an embodiment, the current sensor 130 may provide the sensing current I_CS to the zero control node ND_Z. In an embodiment, if the first power transistor current I_PT1 increases, the sensing current I_CS may need to increase as well. However, the current sensor 130 may respond slowly to changes in the first power transistor current I_PT1 due to fluctuations in the instantaneous output voltage V_OUT, such as an undershoot in the output voltage V_OUT, in order to reduce power consumption. In an embodiment, the current sensor 130 may generate the sensing current I_CS that increases gradually or even remains unchanged, despite an increase in the first power transistor current I_PT1.

In an embodiment, the fast loop circuit 140 may generate the loop current I_FL based on the increased power gate voltage V_PG. In an embodiment, the fast loop circuit 140 may provide the loop current I_FL to the zero control node ND_Z. In an embodiment, the zero gate voltage V_ZG of the zero control node ND_Z may be increased based on a sum of the sensing current I_CS and the loop current I_FL.

In an embodiment, the current flowing through the first transistor TR1 and the second transistor TR2 may increase based on the sum of the sensing current I_CS and the loop current I_FL. In an embodiment, if the current flowing through the first transistor TR1 increases, the resistor R_Z of the first transistor may decrease. As the resistor R_Z of the first transistor decreases, the position of the zero point Z may change from a low-frequency region to a high-frequency region in the frequency domain.

In an embodiment, the fast loop circuit 140 may generate the loop current I_FL in response to a change in the instantaneous output voltage V_OUT, instead of the current sensor 130. The fast loop circuit 140 may push the loop current I_FL to the first transistor TR1, thereby reducing the resistor R_Z of the first transistor TR1 and changing a position of the zero point Z such that the position of the zero point Z in the frequency domain is close to the position of the second dominant pole P2.

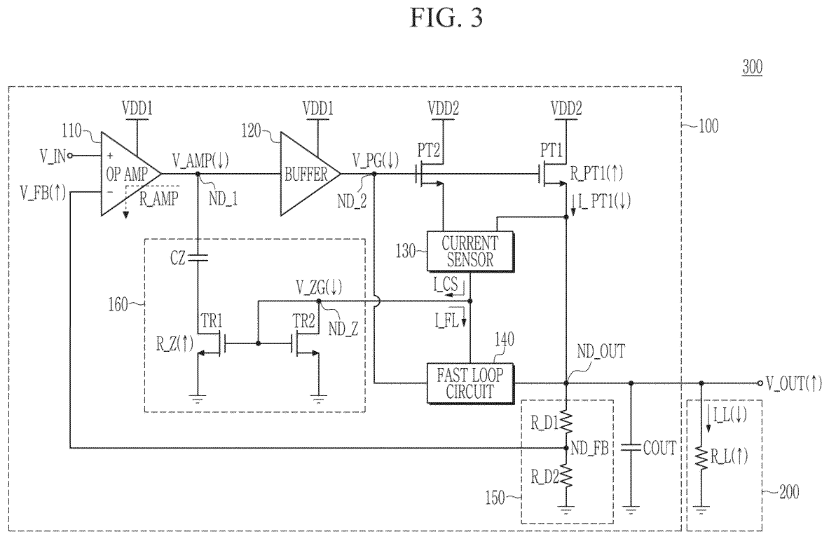

FIG. 3 illustrates a view for describing a regulator that reduces an output voltage of overshoot according to an embodiment.

In FIG. 3, an operation of the regulator 100 is explained in the case where a load of the load circuit 200 decreases. Referring to FIG. 3, as the load of the load circuit 200 increases, a load current I_L may decrease. In an embodiment, as the load current I_L decreases, a load resistance I_R may increase. As the load resistance I_R increases, the position of the second dominant pole P2 in the frequency domain may change from a high frequency region to a low frequency region.

In an embodiment, as the load current I_L decreases, the output voltage V_OUT may increase. In an embodiment, a change in the output voltage V_OUT due to a decrease in the load current I_L may correspond to an overshoot.

In an embodiment, if the output voltage V_OUT increases, the feedback voltage V_FB may increase. In an embodiment, the voltage dividing circuit 150 may generate an increased feedback voltage V_FB based on the increased output voltage V_OUT. The voltage dividing circuit 150 may apply the increased feedback voltage V_FB to the calculation amplifier 110.

In an embodiment, as the feedback voltage V_FB increases, the amplified voltage V_AMP, obtained by amplifying a difference between the input voltage V_IN and the feedback voltage V_FB, may decrease. In an embodiment, the calculation amplifier 110 may apply the decreased amplified voltage V_AMP to the first node ND_1 based on the input voltage V_IN and the increased feedback voltage V_FB.

In an embodiment, as the amplified voltage V_AMP decreases, the power gate voltage V_PG may decrease. In an embodiment, the buffer 120 may apply a decreased power gate voltage V_PG to the second node ND_2 based on the decreased amplified voltage V_AMP.

In an embodiment, as the power gate voltage V_PG decreases, a resistance R_PT1 of the first power transistor may increase. In an embodiment, as the power gate voltage V_PG decreases, the first power transistor current I_PT1 may decrease.

In an embodiment, if the first power transistor current I_PT1 decreases, the sensing current I_CS may need to decrease as well. However, the current sensor 130 may respond slowly to a change in the first power transistor current I_PT1 due to an overshoot of the output voltage V_OUT, or may generate a detection current I_CS that changes slightly. In an embodiment, the current sensor 130 may generate a sensing current I_CS that decreases slowly or to a small extent, even when the first power transistor current I_PT1 decreases.

In an embodiment, the fast loop circuit 140 may pull the loop current I_FL from the zero control node ND_Z based on the increased output voltage V_OUT. The zero gate voltage V_ZG of the zero control node ND_Z may be decreased based on a sum of the sensing current I_CS and the loop current I_FL.

In an embodiment, the current flowing through the first transistor TR1 and the second transistor TR2 may decrease based on the sum of the sensing current I_CS and the loop current I_FL. In an embodiment, if the current flowing through the first transistor TR1 decreases, a resistance R_Z of the first transistor may increase. As the resistance R_Z of the first transistor increases, the position of the zero point Z may change from a high-frequency region to a low-frequency region in the frequency domain.

In an embodiment, the fast loop circuit 140 may change a position of the zero point Z in the frequency domain such that the position of the zero point Z is closer to the position of the second dominant pole P2 by pulling the loop current I_FL from the zero control node ND_Z in response to a change in the instantaneous output voltage V_OUT, instead of relying solely on the current sensor 130.

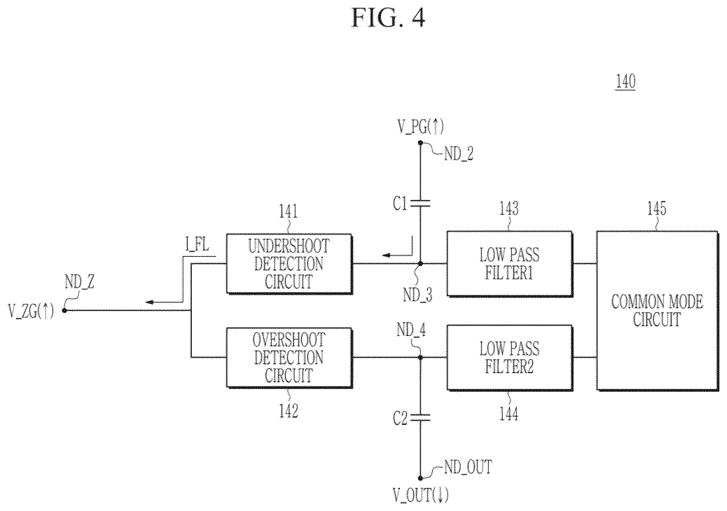

FIG. 4 illustrates a view for describing a fast loop circuit for generating a loop current according to an embodiment.

Referring to FIG. 4, the fast loop circuit 140 may include a first capacitor C1, a second capacitor C2, an undershoot detection circuit 141, an overshoot detection circuit 142, a first low pass filter 143, a second low pass filter 144, and a common mode circuit 145.

In an embodiment, the first capacitor C1 may be connected between the second node ND_2 and the third node ND_3. The first capacitor C1 may be connected between the second node ND_2 and the undershoot detection circuit 141.

In an embodiment, the second capacitor C2 may be connected between the output node ND_OUT and the fourth node ND_4. The second capacitor C2 may be connected between the output node ND_OUT and the overshoot detection circuit 142.

In an embodiment, the undershoot detection circuit 141 may be connected between the zero control node ND_Z and the third node ND_3. In an embodiment, the undershoot detection circuit 141 may detect undershoot of the output voltage V_OUT. The undershoot detection circuit 141 may detect the undershoot when a voltage drop exceeds a predetermined percentage of a nominal voltage or a predetermined voltage threshold.

In an embodiment, the overshoot detection circuit 142 may be connected between the zero control node ND_Z and the fourth node ND_4. In an embodiment, the overshoot detection circuit 142 may detect overshoot of the output voltage V_OUT. The overshoot detection circuit 142 may detect the overshoot when a voltage increase exceeds a predetermined percentage of the nominal voltage or the predetermined voltage threshold.

In an embodiment, the first low pass filter 143 may be connected to the third node ND_3 and the common mode circuit 145. In an embodiment, the first low pass filter 143 may be connected between the undershoot detection circuit 141 and the common mode circuit 145. In an embodiment, the first low-pass filter 143 may block a current of a high-frequency component transmitted through the third node ND_3 from being transmitted to the common mode circuit 145.

In an embodiment, the second low pass filter 144 may be connected to the fourth node ND_4 and the common mode circuit 145. In an embodiment, the second low pass filter 144 may be connected between the overshoot detection circuit 142 and the common mode circuit 145. In an embodiment, the second low-pass filter 144 may block a current of a high-frequency component transmitted through the fourth node ND_4 from being transmitted to the common mode circuit 145.

In an embodiment, the common mode circuit 145 may apply a same DC voltage to the third node ND_3 and the fourth node ND_4.

In an embodiment, if a change in the output voltage V_OUT corresponds to an undershoot, the output voltage V_OUT may decrease and the power gate voltage V_PG may increase. In an embodiment, if the power gate voltage V_PG applied to the second node ND_2 increases, the first capacitor C1 may provide an AC current corresponding to the increase in the power gate voltage V_PG to the undershoot detection circuit 141 and the first low pass filter 143.

In an embodiment, the undershoot detection circuit 141 may detect an increase in the power gate voltage V_PG through the first capacitor C1 and a decrease in the output voltage V_OUT through the second capacitor C2. The undershoot detection circuit 141 may generate the loop current I_FL based on an increase in the power gate voltage V_PG and a decrease in the output voltage V_OUT. The undershoot detection circuit 141 may provide the loop current I_FL to the zero control node ND_Z. The zero gate voltage V_ZG of the zero control node ND_Z may be increased based on the loop current I_FL.

In an embodiment, an alternating current corresponding to the increase in the power gate voltage V_PG may be a high-frequency component. In an embodiment, the first low pass filter 143 may block the AC current corresponding to the increase in the power gate voltage V_PG from being transmitted to the common mode circuit 145.

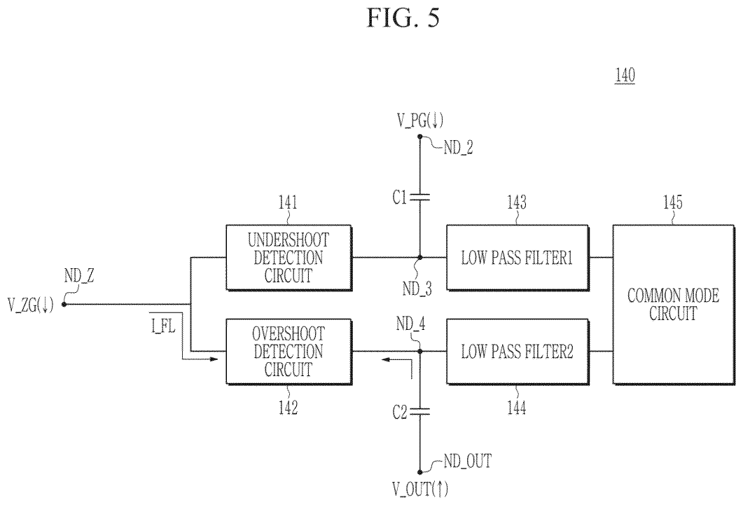

FIG. 5 illustrates a view for describing a fast loop circuit for pooling a loop current according to an embodiment.

Referring to FIG. 5, the fast loop circuit 140 may include a first capacitor C1, a second capacitor C2, an undershoot detection circuit 141, an overshoot detection circuit 142, a first low pass filter 143, a second low pass filter 144, and a common mode circuit 145.

In an embodiment, if a change in the output voltage V_OUT corresponds to an overshoot, the output voltage V_OUT may increase and the power gate voltage V_PG may decrease. In an embodiment, if the output voltage V_OUT applied to the output node ND_OUT increases, the second capacitor C2 may provide the AC current corresponding to the increase in the output voltage V_OUT to the overshoot detection circuit 142 and the second low pass filter 144.

In an embodiment, the overshoot detection circuit 142 may detect an increase in the output voltage V_OUT through the second capacitor C2 and a decrease in the power gate voltage V_PG through the first capacitor C1. The overshoot detection circuit 142 may pull the loop current I_FL from the zero control node ND_Z based on the increase of the output voltage V_OUT and the decrease of the power gate voltage V_PG. The zero gate voltage V_ZG of the zero control node ND_Z may be decreased based on the pulled loop current I_FL.

In an embodiment, an AC current corresponding to an increase in the output voltage V_OUT may be a high-frequency component. In an embodiment, the second low pass filter 144 may block the AC current corresponding to the increase in the output voltage V_OUT from being transmitted to the common mode circuit 145.

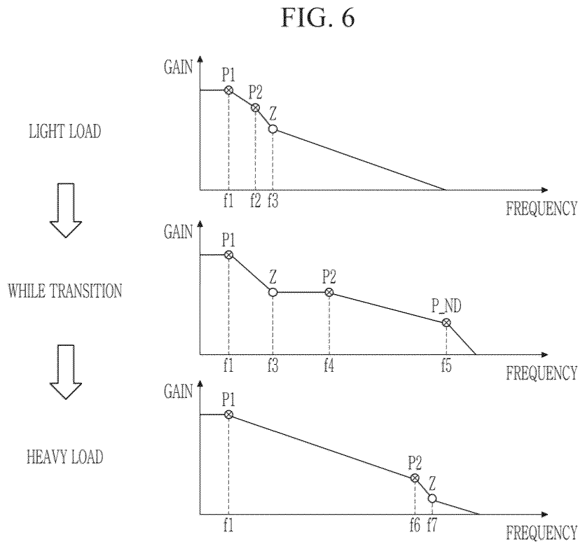

FIG. 6 illustrates a view for describing a slow change of a zero point according to an embodiment.

In FIG. 6, the horizontal axis of a graph represents frequency FREQUENCY, and a vertical axis of the graph represents gain GAIN.

In FIG. 6, an operation of the regulator 100 that does not include the fast loop circuit 140 will be described as an example. Referring to FIGS. 2 and 6, a position of the zero point Z in the frequency domain may be changed based on the sensing current I_CS.

In an embodiment, a load of the load circuit 200 connected to the output node ND_OUT of the regulator 100 may increase from a light load to a heavy load.

In an embodiment, when the load of the load circuit 200 is the light load, a position of the first dominant pole P1 may correspond to a first frequency f1, a position of the second dominant pole P2 may correspond to a second frequency f2, and a position of the zero point Z may correspond to a third frequency f3.

In an embodiment, the load current I_L may increase while the load of the load circuit 200 is switched from the light load to the heavy load. As the load current I_L increases, the output voltage V_OUT may decrease and a load resistance R_L may decrease. As the load resistance R_L decreases, the position of the second dominant pole P2 may change from the second frequency f2 to the fourth frequency f4.

In an embodiment, the position of the zero point Z in the regulator 100 that does not include the fast loop circuit 140 may change based on the sensing current I_CS generated by the current sensor 130, but the current sensor 130 may be slow to respond to an increase in the load current I_L. In an embodiment, the current sensor 130 may be slow in generating an increased sensing current I_CS or may generate the sensing current I_CS that increases less. Accordingly, while a load of the load circuit 200 is switched from the light load to the heavy load, the position of the second dominant pole P2 may change from the second frequency f2 to a fourth frequency f4, but the position of the zero point Z may not change. In an embodiment, while the load of the load circuit 200 is switched from the light load to the heavy load, the position of the zero point may correspond to the third frequency f3.

In the embodiment, if the position of the zero point Z does not change, while the load of the load circuit 200 is switched from the light load to the heavy load, an output voltage of the regulator may oscillate under influence of a non-dominant pole P_ND corresponding to a fifth frequency f5.

In an embodiment, when the load of the load circuit 200 increases to the light load, the position of the second dominant pole P2 may change from the fourth frequency f4 to a sixth frequency f6, and the position of the zero point Z may change from the third frequency (f3) to a seventh frequency f7.

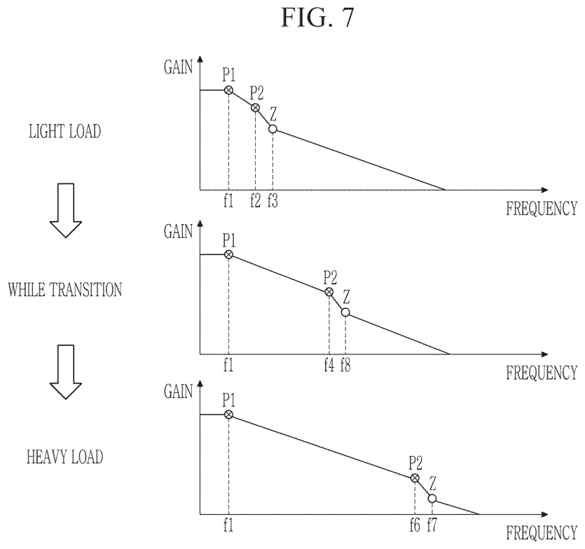

FIG. 7 illustrates a view for describing a rapid change of a zero point according to an embodiment.

In FIG. 7, the horizontal axis of a graph represents frequency FREQUENCY, and a vertical axis of the graph represents gain GAIN.

In FIG. 7, an operation of the regulator 100 including the fast loop circuit 140 will be described as an example. Referring to FIG. 2 and FIG. 7, the position of the zero point Z in the frequency domain may be changed based on a sum of the sensing current I_CS and the loop current I_FL.

In an embodiment, a load of the load circuit 200 connected to the output node ND_OUT of the regulator 100 may increase from a light load to a heavy load.

In an embodiment, when the load of the load circuit 200 is the light load, a position of the first dominant pole P1 may correspond to a first frequency f1, a position of the second dominant pole P2 may correspond to a second frequency f2, and a position of the zero point Z may correspond to a third frequency f3.

In an embodiment, the load current I_L may increase while the load of the load circuit 200 is switched from the light load to the heavy load. As the load current I_L increases, the output voltage V_OUT may decrease and the load resistance R_L may decrease. As the load resistance R_L decreases, the position of the second dominant pole P2 may change from the second frequency f2 to the fourth frequency f4.

In an embodiment, the position of the zero point Z in the regulator 100 including the fast loop circuit 1400 may be changed based on the sensing current I_CS generated by the current sensor 130 and the loop current I_FL generated by the fast loop circuit 140. In an embodiment, the fast loop circuit 140 may push the loop current I_FL to the first transistor TR1, and the resistance R_Z of the first transistor may be decreased based on the loop current I_FL. In an embodiment, when the resistance R_Z of the first transistor decreases, the position of the zero point Z may change from the second frequency f2 to an eighth frequency f8.

In an embodiment, when the position of the zero point Z changes to the eighth frequency f8 according to the loop current I_FL, the zero point Z may cancel the second dominant pole P2 corresponding to the fourth frequency f4, and an oscillation of the output voltage V_OUT of the regulator 100 may be suppressed.

In an embodiment, when the load of the load circuit 200 increases to the high load, the position of the second dominant pole P2 may change from the fourth frequency f4 to the sixth frequency f6 based on an increase in the load current I_L. In an embodiment, when the load of the load circuit 200 increases to the high load, the position of the zero point Z may change from the third frequency f3 to the seventh frequency f7 based on the sum of the sensing current I_CS and the loop current I_FL.

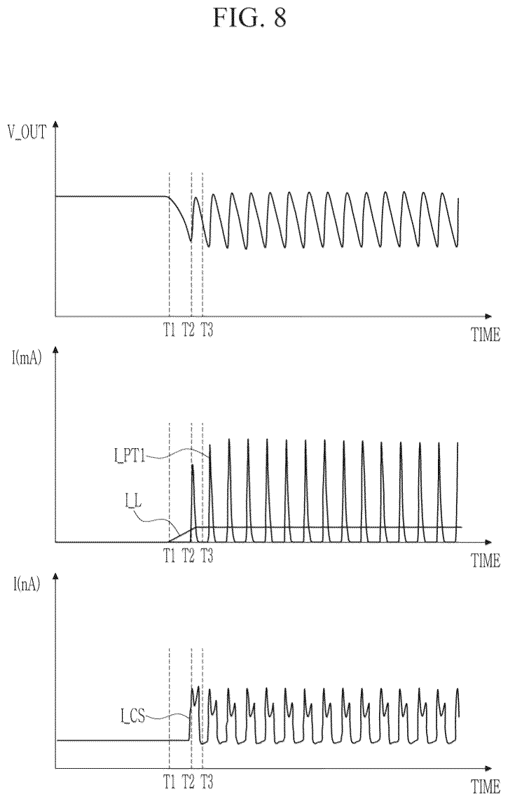

FIG. 8 illustrates a view for describing an oscillation of an output voltage according to an embodiment.

In FIG. 8, a horizontal axis of a graph represents a time TIME, and a vertical axis of the graph represents the output voltage V_OUT or current I. In FIG. 8, an operation of the regulator 100 that does not include the fast loop circuit 140 will be described as an example.

Referring to FIG. 2 and FIG. 8, when the load of the load device 200 increases, the load current I_L may increase. As the load current I_L increases, the output voltage V_OUT may decrease. In the embodiment, during a period from T1 to T2, the load current I_L may increase, and the output voltage V_OUT may decrease.

In an embodiment, when the output voltage V_OUT decreases, the power gate voltage V_PG applied to a gate electrode of the first power transistor PT1 may increase, and when the power gate voltage V_PG increases, the first power transistor current I_PT1 may increase. In an embodiment, at a time T2, the first power transistor current I_PT1 may increase.

In an embodiment, the current sensor 130 may generate the sensing current I_CS, which increases at a slower rate in response to an increase in the first power transistor current I_PT1. In an embodiment, at the time T2, a unit of the sensing current I_CS generated by the current sensor 130 may be in the nanoampere range.

In an embodiment, during a period from T2 to T3, when a small amount of the increased sensing current I_CS is generated, the output voltage V_OUT may increase and then decrease again. As the output voltage V_OUT increases and then decreases, the first power transistor current I_PT1 may also decrease and then increase, and the sensing current I_CS may also decrease and then increase. That is, a small increase in the sensing current I_CS may lead to oscillations in which the output voltage V_OUT repeatedly rises and falls.

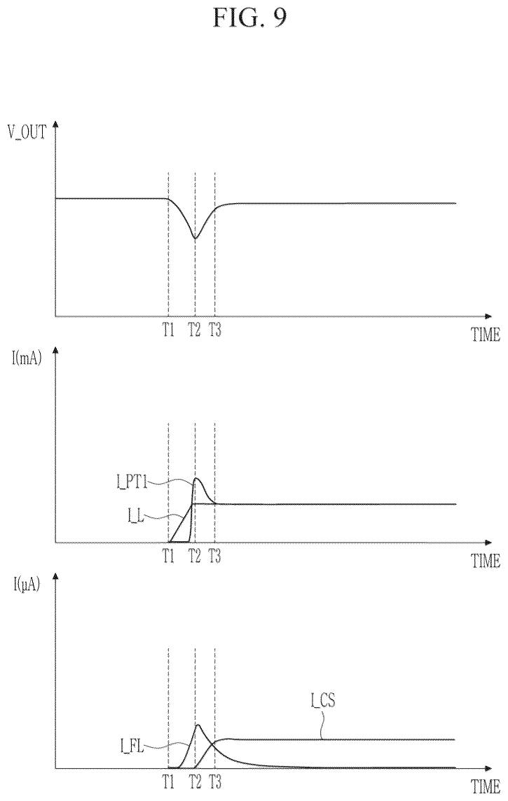

FIG. 9 illustrates a view for describing a regulator that regulates an output voltage based on a loop current according to an embodiment.

In FIG. 9, a horizontal axis of a graph represents a time TIME, and a vertical axis of the graph represents the output voltage V_OUT or current I. In FIG. 8, an operation of the regulator 100 including the fast loop circuit 140 will be described as an example.

Referring to FIG. 2 and FIG. 9, during the period from T1 to T2, when a load of the load device 200 increases, the load current I_L may increase and the output voltage V_OUT may decrease.

In an embodiment, when the output voltage V_OUT decreases, the power gate voltage V_PG may increase, and when the power gate voltage V_PG increases, the first power transistor current I_PT1 may increase. In an embodiment, during the period from T1 to T2, the first power transistor current I_PT1 may increase.

In an embodiment, during the period from T1 to T2, the fast loop circuit 140 may detect an increase in the power gate voltage V_PG, and may generate the loop current I_FL based on the increase in the power gate voltage V_PG. During the period from T1 to T2, the loop current I_FL may increase. During the period from T1 to T2, a unit of the loop current I_FL generated by the fast loop circuit 140 may be in the microampere range.

In an embodiment, during the period from T2 to T3, the output voltage V_OUT may increase based on the increased loop current I_FL.

In an embodiment, during the period from T2 to T3, as the current sensor 130 generates the sensing current I_CS, the sensing current I_CS may increase, and the loop current I_FL may decrease. In an embodiment, from the time T3 onwards, the output voltage V_OUT may be maintained constant based on the sensing current I_CS.

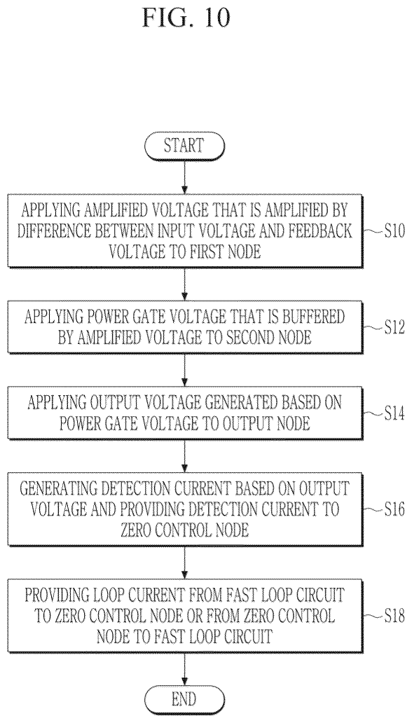

FIG. 10 illustrates a flowchart showing an operating method of a regulator according to an embodiment.

Referring to FIG. 10, in operation S10, the regulator 100 may apply an amplified voltage obtained by amplifying a difference between an input voltage and a feedback voltage, to a first node. The feedback voltage may be a voltage generated based on the output voltage. The first node may be connected to the first transistor TR1 included in the calculation amplifier 110, the buffer 120, and the stabilizing circuit 160.

In operation S12, the regulator 100 may apply a power gate voltage obtained by buffering the amplified voltage to a second node. The second node may be connected to a first power transistor, a second power transistor, and the fast loop circuit 140.

In operation S14, the regulator 100 may apply an output voltage to an output node based on the power gate voltage. The output node may be connected to the fast loop circuit 140, the voltage distribution circuit 150, and the load circuit 200.

In operation S16, the regulator 100 may generate a sensing current based on the output voltage, and may provide the sensing current to a zero control node. The zero control node may be connected to the first transistor TR1 and the second transistor TR2 included in the current sensor 130, the fast loop circuit 140, and the stabilizing circuit 160.

In operation S18, the regulator 100 may provide a loop current from the fast loop circuit to the zero control node, or from the zero control node to the fast loop circuit. In an embodiment, the regulator 100 may provide a loop current to the zero control node in the fast loop circuit 140 when a change in the output voltage corresponds to an undershoot. In an embodiment, the regulator 100 may provide a loop current from the zero control node to the fast loop circuit 140 when a change in the output voltage corresponds to an overshoot.

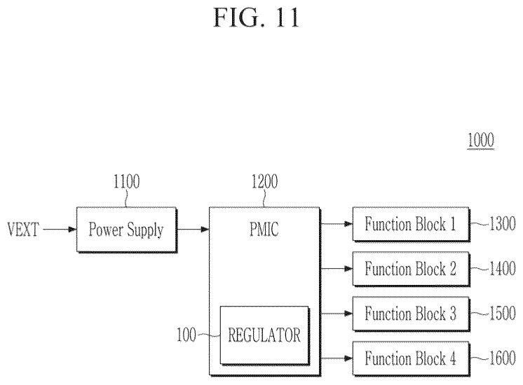

FIG. 11 illustrates a view for describing a system according to an embodiment.

Referring to FIG. 11, the system 1000 may include a power supply 1100, a power management integrated circuit (PMIC) 1200, and functional blocks 1300, 1400, 1500, and 1600.

In an embodiment, the power supply 1100 may provide a power voltage to the PMIC 1200 based on an external voltage VEXT. The PMIC 1200 may supply power to each of the functional blocks 1300, 1400, 1500, and 1600 based on the power voltage provided from the power supply 1100.

In an embodiment, the system 1000 may include a battery, and the external voltage VEXT supplied to the power supply 1100 may be a battery voltage provided by the battery. In an embodiment, the system 1000 may be supplied with power from the outside through a power line, and the external voltage VEXT may be a voltage generated from the power supplied through the power line. In an embodiment, the external voltage VEXT may be a voltage of a power line, or may be a direct current voltage generated by rectifying an alternating current voltage supplied from a power line.

In an embodiment, the PMIC 1200 may include the regulator 100 of FIG. 1. The PMIC 1200 may convert the power voltage provided from the power supply 1100 through the regulator 100, and may provide the converted voltage to the functional blocks 1300, 1400, 1500, and 1600. In an embodiment, the regulator 100 may suppress oscillation of the voltage provided to the functional blocks 1300, 1400, 1500, and 1600 by pushing the sensing current to the first transistor TR1 (in FIG. 1) or pulling the sensing current from the first transistor TR1 (in FIG. 1) based on a change in the voltage provided to the functional blocks 1300, 1400, 1500, and 1600.

Each of the function blocks 1300, 1400, 1500, and 1600 may operate based on the electric power provided from the PMIC 1200. For example, one of the functional blocks 1300, 1400, 1500, and 1600 may be a digital circuit that processes a digital signal, such as an application processor (AP), an analog circuit that processes an analog signal, such as an amplifier, or a circuit that processes a mixed signal, such as an analog-to-digital converter (ADC).

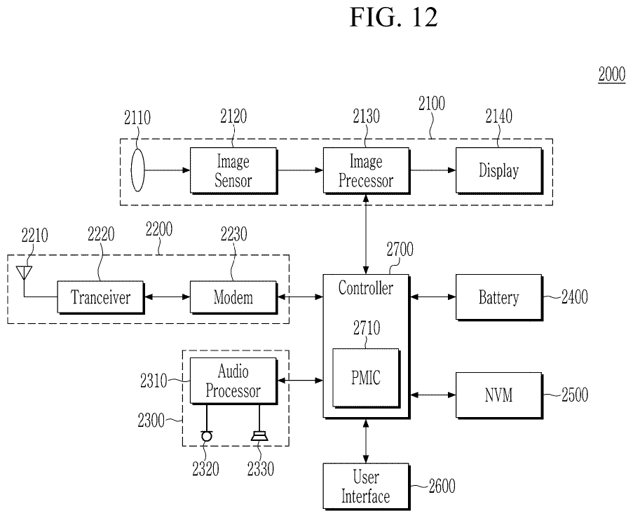

FIG. 12 illustrates a view for describing an electronic device according to an embodiment.

Referring to FIG. 12, the electronic device 2000 may include an imaging system 2100, a wireless transceiver 2200, an audio processing system 2300, a battery 2400, a non-volatile memory device 2500, a user interface 2600, and a controller 2700. In an embodiment, the electronic device 2000 may be a computer, a laptop, or a mobile phone. In an embodiment, the controller 2700 may control a general operation of the electronic device 2000.

In an embodiment, the imaging system 2100 may include a lens 2110, an image sensor 2120, an image processor 2130, and a display 2140. The image processor 2130 may convert a real-world image into image data through the lens 2110 and the image sensor 2120. The display 2140 may display image data signals generated by the image processor 2130 or image data to be provided to a user. The display 2140 may be formed of a liquid crystal display (LCD) or an organic light emitting diode (OLED). When the LCD or OLED is implemented in a touch screen manner, the display 2140 may also operate together with the user interface 2600.

In an embodiment, the wireless transceiver 2200 may include an antenna 2210, a transceiver 2220, and a modem 2230. The wireless transceiver 2200 may perform a wireless communication function. The transceiver 2220 may adjust a frequency of a signal transmitted through the antenna 2210 or amplify the signal, and may adjust a frequency of a signal received through the antenna 2210 or amplify the signal. The modem 2230 may include a transmitter that encodes and modulates a signal to be transmitted and a receiver that demodulates and decodes a signal received through the antenna 2210.

In an embodiment, the audio processing system 2300 may include an audio processor 2310, a microphone 2320, and a speaker 2330. The audio processing system 2300 may configure a codec, and the codec may include a data codec and an audio codec. Data codecs may process packet data, etc., and audio codecs may process audio signals such as voice and multimedia files. In an embodiment, the audio processing system 2300 may perform a function of converting a digital audio signal received from the modem 2230 into an analog signal through an audio codec and playing the converted signal, or converting an analog audio signal generated from the microphone 2320 into a digital audio signal through an audio codec and transmitting the converted signal to the modem 2230.

In an embodiment, the non-volatile memory device 2500 may be a device that stores data. In an embodiment, the non-volatile memory device 2500 may be a NAND flash memory.

In an embodiment, the controller 2700 may be provided as a system on chip (SoC) that runs an application program, an operating system, etc., and may be implemented as one or more processors. In an embodiment, the controller 2700 may include a PMIC 2710. In an embodiment, the PMIC 2710 may convert a level of voltage supplied from the battery 2400, and may output the voltage. The PMIC 2710 may include the regulator 100 of FIG. 1. In an embodiment, the PMIC 2710 may suppress oscillation of an output voltage by pushing a sensing current to the first transistor TR1 (in FIG. 1) or pulling the sensing current from the first transistor TR1 (in FIG. 1) based on a change in the output voltage.

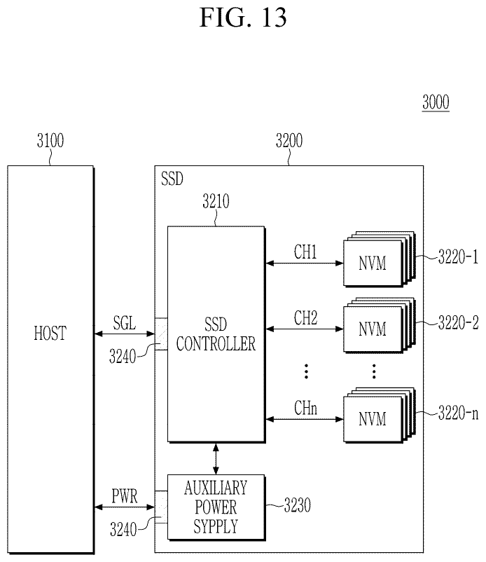

FIG. 13 illustrates a view for describing a storage system according to an embodiment.

Referring to FIG. 13, the storage system 3000 may include a host 3100 and a solid state drive (SSD) 3200.

In an embodiment, the SSD 3200 may include an SSD controller 3210, a plurality of non-volatile memory devices 3220-1 to 3220-n, and an auxiliary power supply 3230.

In an embodiment, the SSD controller 3210 may be connected to the non-volatile memory devices 3220-1 to 3220-n through a plurality of channels CH1 to CHn.

In an embodiment, the SSD controller 3210 may transmit and receive a signal SGL with the host 3100 through a signal connector 3240. In an embodiment, the signal SGL may include a command, an address, and data, etc. The SSD controller 3210 may store data in the non-volatile memory devices 3220-1 to 3220-n or read data stored in the non-volatile memory devices 3220-1 to 3220-n according to a command from the host 3100.

In an embodiment, the non-volatile memory devices 3220-1 to 3220-n may be used as a storage media of the SSD 3200. In an embodiment, each of the non-volatile memory devices 323-1, 323-2, . . . , and 323-n may include a memory cell array formed in a three-dimensional structure on a substrate. A memory cell array may include a plurality of memory cells that store data.

In an embodiment, the auxiliary power supply 3230 may receive power PWR from the host 3100 through the power connector 3250 to supply power to the SSD controller 3210. In an embodiment, the auxiliary power supply 3230 may be positioned within the SSD 3200, or may be positioned external to the SSD 3200. In an embodiment, the auxiliary power supply 3230 may be positioned on s main board, and may provide auxiliary power to the SSD 3200. In an embodiment, the auxiliary power supply 3230 may include a regulator circuit 100 of FIG. 1. In an embodiment, the auxiliary power supply 3230 may suppress oscillation of the voltage provided to the SSD controller 3210 by pushing a sensing current to the first transistor TR1 (in FIG. 1) or pulling the sensing current from the first transistor TR1 (in FIG. 1) based on a change in the voltage provided to the SSD controller 3210.

While this disclosure has been described in connection with what is presently considered to be practical embodiments, it is to be understood that the disclosure is not limited to the disclosed embodiments, but, on the contrary, is intended to cover various modifications and equivalent dispositions included within the spirit and scope of the appended claims.

What is claimed is:

1. A regulator comprising:
an amplifier configured to amplify a difference between an input voltage and a feedback voltage to obtain an amplified voltage, and apply the amplified voltage to a first node;
a buffer connected to the first node and configured to buffer the amplified voltage to obtain a power gate voltage and apply the power gate voltage to a second node;
a first power transistor comprising a gate electrode connected to the second node, a first electrode connected to a power supply voltage, and a second electrode connected to an output node;
a voltage dividing circuit configured to generate the feedback voltage based on an output voltage of the output node;
a current sensor configured to generate an sensing current based on a current of the first power transistor;
a loop circuit configured to generate a loop current based on the power gate voltage and the output voltage; and
a stabilizing circuit configured to suppress oscillation of the output voltage based on a sum current of the sensing current and the loop current.

2. The regulator of claim 1, wherein the stabilizing circuit comprises:
a first transistor through which the sum current flows; and
a second transistor through which a current obtained by mirroring the sum current flows.

3. The regulator of claim 2, wherein
the loop circuit is further configured to supply the loop current to the first transistor based on a change in the output voltage corresponding to an undershoot, to cause a resistance of the first transistor to decrease.

4. The regulator of claim 2, wherein
the loop circuit is further configured to pull the loop current from the first transistor based on a change in the output voltage corresponding to an overshoot, to cause a resistance of the first transistor to increase.

5. The regulator of claim 1, wherein the loop circuit comprises:
an undershoot detection circuit configured to detect an undershoot of the output voltage;
an overshoot detection circuit configured to detect an overshoot of the output voltage;
a first capacitor connected between the second node and the undershoot detection circuit; and
a second capacitor connected between the output node and the overshoot detection circuit.

6. The regulator of claim 5, wherein
the undershoot detection circuit is further configured to detect an increase in the power gate voltage through the first capacitor and a decrease in the output voltage through the second capacitor based on the change in the output voltage corresponding to the undershoot, generate the loop current based on the increase in the power gate voltage and the decrease in the output voltage, and push the loop current to the first transistor.

7. The regulator of claim 5, wherein
the overshoot detection circuit is further configured to detect an increase in the output voltage through the second capacitor and the decrease in the power gate voltage through the first capacitor based on the change in the output voltage corresponding to the overshoot, and pull the loop current from the first transistor based on the increase in the output voltage and the decrease in the power gate voltage.

8. The regulator of claim 5, wherein the loop circuit comprises:
a common mode circuit;
a first low pass filter connected between the common mode circuit and the undershoot detection circuit; and
a second low pass filter connected between the common mode circuit and the overshoot detection circuit.

9. The regulator of claim 1, further comprising
a second power transistor comprising a gate electrode connected to the second node, a first electrode connected to the power supply voltage, and a second electrode connected to the current sensor.

10. A regulator comprising:
a calculation amplifier configured to amplify a difference between an input voltage and a feedback voltage to obtain an amplified voltage, and output the amplified voltage to a first node;
a buffer connected to the first node and configured to buffer the amplified voltage to obtain a power gate voltage and apply the amplified voltage to a second node;
a power transistor connected to the second node and the output node;
a current sensor configured to generate an sensing current based on a current of the power transistor and provide the sensing current to a zero control node;
a first transistor comprising a gate electrode connected to the zero point control node, a first electrode connected to the first node, and a second electrode connected to ground; and
a loop circuit connected to the second node, the output node, and the zero control node, and configured to increase or decrease a zero gate voltage of the zero control node based on a change in a load current flowing in a load connected to the output node.

11. The regulator of claim 10, wherein
the loop circuit is further configured to increase the zero gate voltage based on an increase in the load current, and
a resistance of the zero transistor decreases based on a magnitude of the zero gate voltage.

12. The regulator of claim 10, wherein
the loop circuit is further configured to decrease the zero gate voltage based on a decrease in the load current, and
a resistance of the zero transistor increases based on a magnitude of the zero gate voltage.

13. The regulator of claim 10, wherein the loop circuit comprises:
a first capacitor connected to the second node;
a second capacitor connected to the output node;
an undershoot detection circuit configured to detect a change in the power gate voltage through the first capacitor; and
an overshoot detection circuit configured to detect a change in the output voltage through the second capacitor.

14. The regulator of claim 13, wherein
the undershoot detection circuit is further configured to detect an increase in the power gate voltage and a decrease in the output voltage based on the increase in the load current, and increase the zero gate voltage based on the power gate voltage and the output voltage.

15. The regulator of claim 13, wherein
the overshoot detection circuit is further configured to detect an increase in the output voltage and a decrease in the power gate voltage based on the decrease in the load current decreases, and decrease the zero gate voltage based on the output voltage and the power gate voltage.

16. An operating method of a regulator, the operating method comprising:
amplifying a difference between an input voltage and a feedback voltage to obtain an amplified voltage;
applying the amplified voltage to a first node connected to a buffer;
buffering the amplified voltage to obtain a power gate voltage;
applying the power gate voltage to a second node connected to a power transistor and a loop circuit;
applying an output voltage generated based on the power gate voltage to an output node connected to a current sensor and the loop circuit;
generating a sensing current based on the output voltage and providing the sensing current to a zero control node connected to a gate electrode of the first transistor and the loop circuit; and
providing a loop current from the loop circuit to the zero control node or from the zero control node to the loop circuit based on a change in the output voltage.

17. The operating method of claim 16, further comprising:
detecting an increase in the power gate voltage and a decrease in the output voltage based on the change in the output voltage corresponding to an undershoot; and
providing the loop current from the loop circuit to the zero control node based on the power gate voltage and the output voltage.

18. The operating method of claim 17, further comprising
providing the loop current to the zero control node, and
decreasing a resistance of the first transistor based on the sensing current and the loop current.

19. The operating method of claim 16, further comprising:
detecting an increase in the output voltage and a decrease in the power gate voltage based on the change in the output voltage corresponding to an overshoot; and
providing the loop current from the zero control node to the loop circuit based on the output voltage and the power gate voltage.

20. The operating method of claim 19, further comprising
providing the loop current to the loop circuit, and
increasing a resistance of the first transistor based on the sensing current and the loop current.
